(19) United States
(12) Patent Application Publication
(10) Pub. No.: US 2026/0029380 A1
(43) Pub. Date: Jan. 29, 2026

(54) IMAGING SYSTEM, METHOD, AND IMAGE PROCESSING APPARATUS

(71) Applicant: TERUMO KABUSHIKI KAISHA, Tokyo (JP)

(72) Inventor: Yuki SAKAGUCHI, Fujisawa Kanagawa (JP)

(21) Appl. No.: 19/342,345

(22) Filed: Sep. 26, 2025

Related U.S. Application Data
(63) Continuation of application No. PCT/JP2024/002128, filed on Jan. 25, 2024.

(30) Foreign Application Priority Data
Mar. 28, 2023 (JP) 2023-052326

(51) Int. Cl. G01N 29/06; G01N 29/04; G01N 29/24; G01N 29/265; G01N 29/30; H04N 23/50; H04N 23/56

(52) U.S. Cl. CPC G01N 29/0672; G01N 29/048; G01N 29/0645; G01N 29/2475; G01N 29/265; G01N 29/30; H04N 23/555; H04N 23/56; G01N 2291/02483

(57) ABSTRACT

An imaging system for generating tomographic images of a luminal organ includes a catheter that includes: ultrasound and optical sensors, a motor drive unit configured to move the ultrasound and optical sensors in a longitudinal direction, a display, and a processor configured to execute the steps of: controlling the drive unit to move the optical sensor in a first period and generating optical coherence tomographic images in the first period, each optical image being associated with a location of the optical sensor, controlling the drive unit to move the ultrasound sensor in a second period and generating ultrasound tomographic images in the second time period, each ultrasound image being associated with a location of the ultrasound sensor, generating a first screen that shows an optical coherence tomographic image and an ultrasound tomographic image associated with a same location, and control the display to display the first screen.

### CROSS-REFERENCE TO RELATED APPLICATION

This application is a continuation of International Patent Application No. PCT/JP2024/002128 filed Jan. 25, 2024, which is based upon and claims the benefit of priority from Japanese Patent Application No. 2023-052326, filed Mar. 28, 2023, the entire contents of which are incorporated herein by reference.

### BACKGROUND

### Technical Field

Embodiments of the present disclosure relate to an imaging system, a method, and an image processing apparatus.

### Background Art

One of treatment methods for a narrow section in a coronary artery is a procedure called percutaneous coronary intervention (PCI). PCI is a minimally invasive treatment in which a narrowed lesion is expanded with a balloon catheter and a stent is placed to reconstruct the blood vessel. During or after PCI, the condition inside the blood vessel can be observed with intravascular ultrasound (IVUS) or optical coherence tomography (OCT) using an imaging catheter.

### SUMMARY

Such a catheter provided with both an IVUS sensor and an OCT sensor is configured to enable observation using only the IVUS sensor, observation using only the OCT sensor, and observation using both the sensors. The IVUS and OCT sensors each have advantages depending on the characteristics of the observation target, and performing observation with both the sensors makes it possible to acquire highly accurate information. Therefore, using IVUS and OCT images acquired from the same observation target to determine the characteristics of that target is effective. However, while it is easy to identify an IVUS image and an OCT image from the same imaging position when using both sensors, it is difficult to identify a combination of images from the same imaging position for IVUS and OCT images acquired through observation using only one sensor or at different timings.

Embodiments of the present disclosure provide an imaging system, for example, capable of presenting an IVUS image and an OCT image identical to each other in imaging position.

An imaging system for generating tomographic images of a luminal organ, comprises a catheter that includes: an ultrasound sensor configured to transmit ultrasound waves and receive the waves reflected by the luminal organ in a radial direction of the catheter when the catheter is inserted in the luminal organ, and an optical sensor configured to emit near infrared light and receive the light reflected by the luminal organ in the radial direction when the catheter is inserted in the luminal organ; a motor drive unit connectable to the catheter and configured to move the ultrasound sensor and the optical sensor in a longitudinal direction of the catheter; a display; a memory that stores a program; and a processor configured to execute the program to perform the steps of: controlling the motor drive unit to move the optical sensor in a first time period and generating a plurality of optical coherence tomographic images based on light received by the optical sensor in the first time period, each of the optical coherence tomographic images being associated with a location of the optical sensor; controlling the motor drive unit to move the ultrasound sensor in a second time period that is subsequent to the first time period and generating a plurality of ultrasound tomographic images based on waves received by the ultrasound sensor in the second time period, each of the ultrasound tomographic images being associated with a location of the ultrasound sensor; generating a first screen that shows one of the optical coherence tomographic images and one of the ultrasound tomographic images that are associated with a same location; and control the display to display the first screen.

According to one aspect, it is possible to provide an imaging system, for example, capable of presenting an IVUS image and an OCT image identical to each other in imaging position.

### BRIEF DESCRIPTION OF DRAWINGS

FIG. 1 is a diagram illustrating a configuration example of an image diagnosis apparatus.

FIG. 2 is a diagram illustrating a general structure of an imaging catheter.

FIG. 3 is a diagram illustrating a cross section of a blood vessel through which a sensor unit is inserted.

FIG. 4A is a diagram of a tomographic image.

FIG. 4B is a diagram of a tomographic image.

FIG. 5 is a block diagram illustrating a configuration example of an image processing apparatus.

FIG. 6 is a flowchart of a display processing procedure for tomographic images.

FIG. 7A is a diagram illustrating a screen example.

FIG. 7B is a diagram illustrating a screen example.

FIG. 8 is a diagram illustrating a screen example.

FIG. 9 is a diagram illustrating a configuration example of an OCT model.

FIG. 10 is a flowchart of a display processing procedure for tomographic images.

FIG. 11 is an explanatory diagram of a merkmal.

FIG. 12 is a flowchart of a display processing procedure for tomographic images.

FIG. 13 is a diagram illustrating a screen example.

FIG. 14 is a diagram illustrating another example of a screen.

### DETAILED DESCRIPTION

Hereinafter, a program, an image processing method, and an image processing apparatus according to the present disclosure will be described in detail with reference to the drawings illustrating embodiments thereof. In each of the following embodiments, a cardiac catheter treatment as an endovascular treatment will be described as an example, but a luminal organ to be subjected to a catheter treatment is not limited to a blood vessel, and may be other luminal organs such as a bile duct, a pancreatic duct, a bronchus, and an intestine.

### First Embodiment

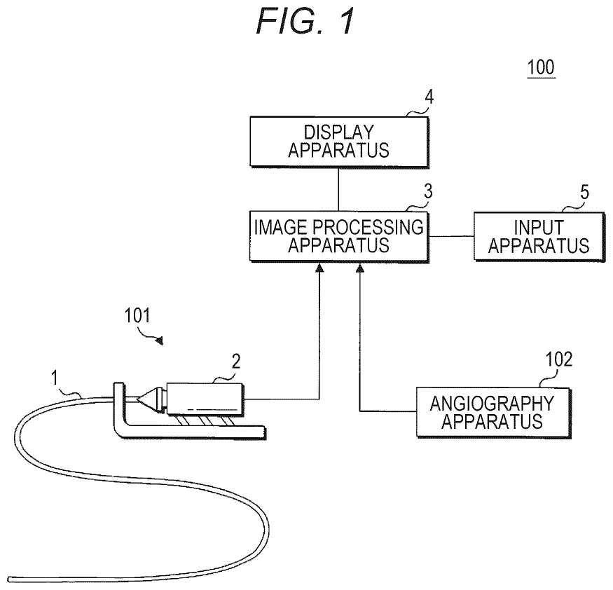

FIG. 1 is a diagram illustrating a configuration example of an image diagnosis apparatus 100. In a first embodiment, an image diagnosis apparatus using a dual type catheter having functions of both intravascular ultrasound (IVUS) and optical coherence tomography (OCT) will be described. In the dual type catheter, a mode of acquiring an ultrasonic tomographic image only by IVUS, a mode of acquiring an optical coherence tomographic image only by OCT, and a mode of acquiring both tomographic images by IVUS and OCT are provided, and these modes can be switched. Hereinafter, the ultrasonic tomographic image and the optical coherence tomographic image are referred to as an IVUS image and an OCT image, respectively. The IVUS image and the OCT image are examples of tomographic images of a blood vessel, and the IVUS image and the OCT image each include a lateral tomographic image that is a cross-sectional image in radial directions of the blood vessel and a longitudinal tomographic image that is a cross-sectional image in long-axis directions of the blood vessel.

The image diagnosis apparatus 100 according to the present embodiment includes an intravascular inspection apparatus 101, an angiography apparatus 102, an image processing apparatus 3, a display apparatus 4, and an input apparatus 5. The intravascular inspection apparatus 101 includes an imaging catheter 1 and a motor drive unit (MDU) 2. The imaging catheter 1 is connected to the image processing apparatus 3 via the MDU 2. The display apparatus 4 and the input apparatus 5 are connected to the image processing apparatus 3. The display apparatus 4 is, for example, a liquid crystal display (LCD) or an organic electroluminescence (EL) display, and the input apparatus 5 is, for example, a keyboard, a mouse, a touch panel, or a microphone. The input apparatus 5 and the image processing apparatus 3 may be integrally configured. Furthermore, the input apparatus 5 may be a sensor that receives a gesture input or a line-of-sight input, for example.

The angiography apparatus 102 is connected to the image processing apparatus 3. The angiography apparatus 102 images a blood vessel from outside a living body of a patient using X-rays while a contrast agent is injected into the blood vessel of the patient to acquire an angiogram that is a fluoroscopic image of the blood vessel. The angiography apparatus 102 includes an X-ray source and an X-ray sensor, and images an X-ray fluoroscopic image of the patient as the X-ray sensor receives X-rays emitted from the X-ray source. Note that the imaging catheter 1 is provided with a marker that does not allow X-rays to pass through, and the position of the imaging catheter 1 (i.e., the marker) is visualized in an angiogram. The angiography apparatus 102 outputs an angiogram acquired by performing imaging to the image processing apparatus 3, and causes the display apparatus 4 to display the angiogram via the image processing apparatus 3. Note that the display apparatus 4 displays the angiogram and a tomographic image captured by using the imaging catheter 1.

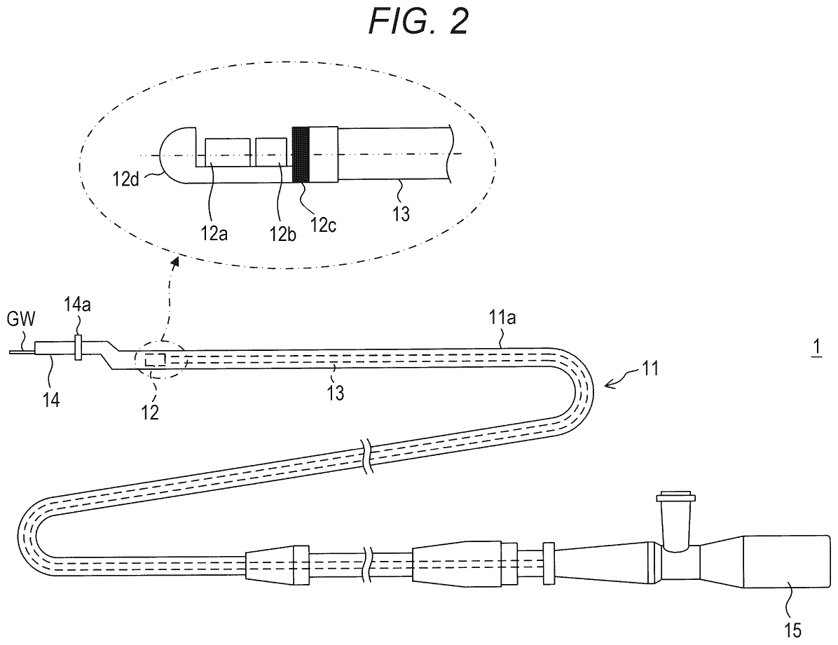

FIG. 2 is a diagram illustrating the general structure of the imaging catheter 1. Note that a region indicated by a one-dot chain line, which is illustrated on an upper side in FIG. 2, is an enlarged view of a region indicated by a one-dot chain line on a lower side. The imaging catheter 1 includes a probe 11 and a connector portion 15 disposed at an end portion of the probe 11. The probe 11 is connected to the MDU 2 via the connector portion 15. Hereinafter, it will be described that a side far from the connector portion 15 of the imaging catheter 1 is referred to as a distal end side or simply a distal side, and a side near the connector portion 15 is referred to as a proximal end side or simply proximal side. The probe 11 includes a catheter sheath 11a, and a guide wire insertion portion 14 through which it is possible to insert a guide wire GW is provided at its distal end portion. The guide wire insertion portion 14 forms a guide wire lumen, receives the guide wire GW inserted in advance into a blood vessel, and is used to guide the probe 11 to an affected part with the guide wire GW. The catheter sheath 11a forms a tube portion continuous from a connection portion with the guide wire insertion portion 14 to a connection portion with the connector portion 15. A shaft 13 is inserted into the catheter sheath 11a, and a sensor unit 12 is connected to a distal end side of the shaft 13.

The sensor unit 12 includes a housing 12d, and a distal end side of the housing 12d is formed into a hemispherical shape for suppressing friction and catching with an inner surface of the catheter sheath 11a. In the housing 12d, an ultrasound transmitter and receiver 12a (hereinafter also referred to as an IVUS sensor, an ultrasound sensor, or an ultrasound transducer) that transmits ultrasonic waves into the blood vessel and receives reflected waves from an inside of the blood vessel and an optical transmitter and receiver 12b (hereinafter also referred to as an OCT sensor, an optical sensor, or an optical transceiver) that transmits near-infrared light into the blood vessel and receives reflected light from the inside of the blood vessel are disposed. In the example illustrated in FIG. 2, the IVUS sensor 12a is provided on a distal end side of the probe 11, and the OCT sensor 12b is provided on its proximal end side. In the imaging catheter 1, the IVUS sensor 12a and the OCT sensor 12b are attached when a direction (one of the radial directions of the shaft 13) forming approximately 90 degrees with respect to axial directions of the shaft 13 is regarded as a transmission or reception direction of ultrasonic waves or near-infrared light. Note that the IVUS sensor 12a and the OCT sensor 12b are desirably attached slightly shifted in the radial directions for preventing reflected waves or reflected light on the inner surface of the catheter sheath 11a from being received.

An electric signal cable (not illustrated) connected to the IVUS sensor 12a and an optical fiber cable (not illustrated) connected to the OCT sensor 12b are inserted into the shaft 13. The distal end side of the probe 11 is first inserted into the blood vessel. The sensor unit 12 and the shaft 13 are movable forward or rearward inside the catheter sheath 11a and are rotatable in one of circumferential directions. The sensor unit 12 and the shaft 13 rotate about a central axis of the shaft 13, which serves as a rotation axis. In the image diagnosis apparatus 100, in which an imaging core including the sensor unit 12 and the shaft 13 is used, the condition inside the blood vessel is measured based on an IVUS image captured from the inside of the blood vessel and/or an OCT image captured from the inside of the blood vessel.

The MDU 2 is a drive unit to which the probe 11 (imaging catheter 1) is detachably attached via the connector portion 15, and controls operation of the imaging catheter 1 inserted into the blood vessel as a built-in motor is driven in accordance with an operation of a medical worker. For example, the MDU 2 performs a pull-back operation of pulling, toward the MDU 2 itself at a constant speed, and rotating, in one of the circumferential directions, the sensor unit 12 and the shaft 13 inserted into the probe 11. The sensor unit 12 moves from the distal end side toward the proximal end side due to the pull-back operation, rotates, continuously scans the inside of the blood vessel at predetermined time intervals, receives reflected waves, from the inside of the blood vessel, of ultrasonic waves that the IVUS sensor 12a has transmitted, and receives reflected light, from the inside of the blood vessel, of light that the OCT sensor 12b has transmitted. The MDU 2 outputs reflected wave data of the ultrasonic waves, which the IVUS sensor 12a has received, and reflected light data that the OCT sensor 12b has received to the image processing apparatus 3.

The image processing apparatus 3 acquires, via the MDU 2, a signal data set representing the reflected wave data (ultrasonic signals) of the ultrasonic waves, which the IVUS sensor 12a has received, and a signal data set representing the reflected light data that the OCT sensor 12b has received. The image processing apparatus 3 generates ultrasonic line data from the signal data set of the ultrasonic waves, and constructs, based on the generated ultrasonic line data, IVUS lateral tomographic images (ultrasonic lateral tomographic images) acquired by imaging lateral tomograms (lateral cross sections) of the blood vessel and IVUS longitudinal tomographic images (ultrasonic longitudinal tomographic images) acquired by imaging longitudinal tomograms (longitudinal cross sections) of the blood vessel. In addition, the image processing apparatus 3 generates optical line data from the signal data set of the reflected light, and constructs, based on the generated optical line data, OCT lateral tomographic images (optical coherence lateral tomographic images) acquired by imaging lateral tomograms of the blood vessel and OCT longitudinal tomographic images (optical coherence longitudinal tomographic images) acquired by imaging longitudinal tomograms of the blood vessel. Note that the processing of generating ultrasonic line data from a signal data set of ultrasonic waves and the processing of generating optical line data from a signal data set of reflected light may be executed by the MDU 2, in addition to the image processing apparatus 3. In this case, the image processing apparatus 3 is configured to acquire the ultrasonic line data and the optical line data from the MDU 2.

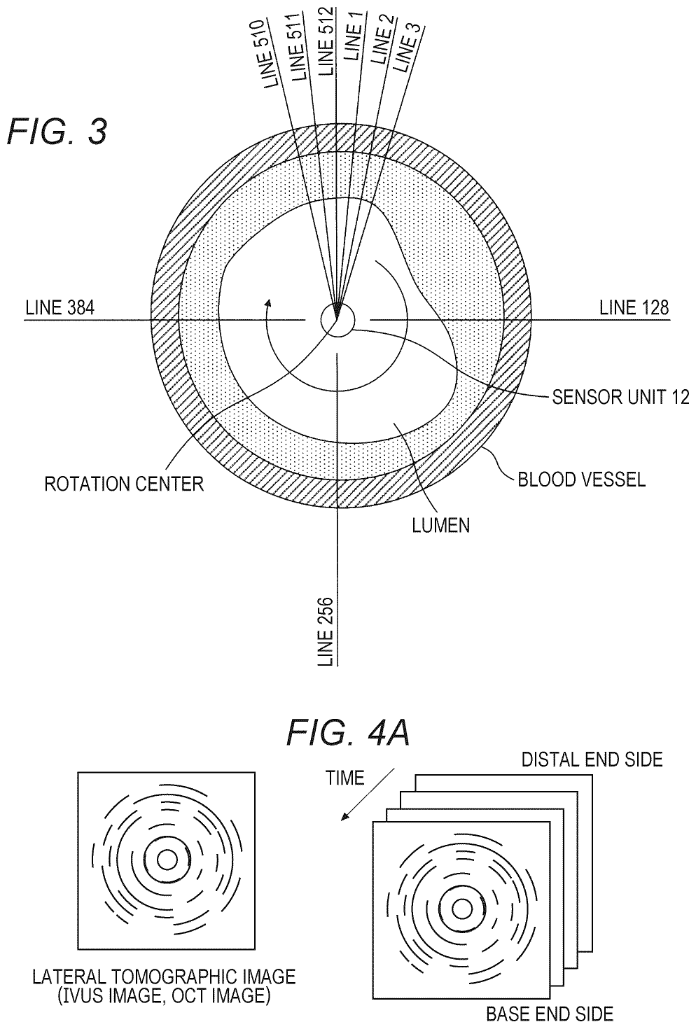

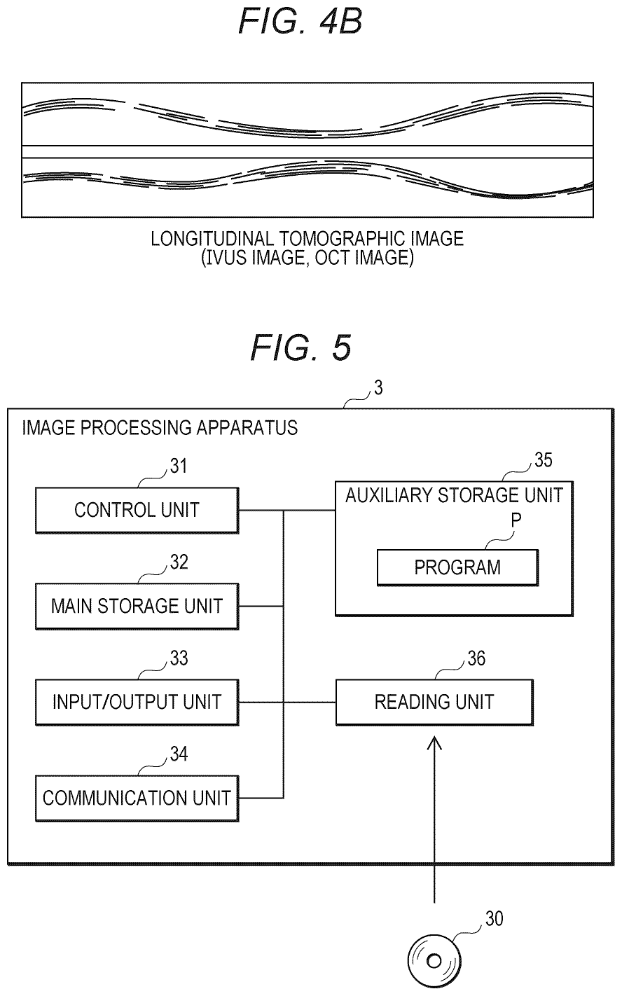

Signal data sets that the IVUS sensor 12a and the OCT sensor 12b acquire and tomographic images generated from the signal data sets will now be described. FIG. 3 is a diagram illustrating a cross section of a blood vessel into which the sensor unit 12 is inserted, and FIGS. 4A and 4B are explanatory diagrams of tomographic images. Operation of the IVUS sensor 12a and the OCT sensor 12b in a blood vessel and signal data sets (ultrasonic line data and optical line data) that the IVUS sensor 12a and the OCT sensor 12b acquire will first be described with reference to FIG. 3. When capturing of tomographic images is started in a state where the imaging core is inserted into a blood vessel, the imaging core rotates about the central axis of the shaft 13, which serves as a rotation center, in a direction indicated by an arrow. At this time, the IVUS sensor 12a transmits and receives ultrasonic waves at each rotation angle. Lines 1, 2, . . . 512 each indicate the transmission or reception direction of ultrasonic waves at each rotation angle. In the present embodiment, the IVUS sensor 12a rotates 360 degrees corresponding to one rotation inside the blood vessel and intermittently transmits and receives ultrasonic waves 512 times. Since the IVUS sensor 12a acquires data corresponding to one line in the transmission and reception directions during one cycle of transmission and reception of ultrasonic waves, it is possible to acquire 512 pieces of ultrasonic line data radially extending from the rotation center during one rotation. The 512 pieces of ultrasonic line data are dense near the rotation center, but become sparse with distance from the rotation center. Therefore, the image processing apparatus 3 performs known interpolation processing to generate pixels in an empty space between each two of the lines, making it possible to construct such a two-dimensional ultrasonic tomographic image as illustrated on a left side in FIG. 4A. The two-dimensional ultrasonic tomographic image generated from the 512 pieces of line data in this manner is referred to as one frame of an IVUS lateral tomographic image. Note that, since the sensor unit 12 moves inside the blood vessel and performs scanning, one frame of an IVUS lateral tomographic image is acquired at each position when the sensor unit has rotated once within a movement range. That is, since one frame of an IVUS lateral tomographic image is acquired at each position from the distal end side to the proximal end side of the probe 11 within the movement range, a plurality of frames of IVUS lateral tomographic image are acquired within the movement range, as illustrated on a right side in FIG. 4A.

In addition, the image processing apparatus 3 arranges pieces of ultrasound line data each received at an identical rotation angle in accordance with an acquisition position of each of the pieces of line data (position in the long-axis directions of the blood vessel), among pieces of ultrasound line data acquired within the movement range, making it possible to generate a two-dimensional ultrasound tomographic image as illustrated in FIG. 4B. Specifically, the image processing apparatus 3 generates a two-dimensional ultrasound tomographic image from pieces of line data each received at a desired rotation angle (pieces of line data of the identical line number) and pieces of line data each received at a rotation angle acquired by adding 180 degrees to the desired rotation angle (pieces of line data of the line number acquired by adding 256 to the identical line number), where such a two-dimensional ultrasound tomographic image is referred to as an IVUS longitudinal tomographic image.

Similarly, the OCT sensor 12b also transmits and receives near-infrared light (measurement light) at each rotation angle. Since the OCT sensor 12b also rotates 360 degrees inside the blood vessel and transmits and receives measurement light 512 times, it is possible to acquire 512 pieces of optical line data radially extending from the rotation center during one rotation. Also for optical line data, the image processing apparatus 3 performs known interpolation processing to generate pixels in an empty space between each two of the lines, making it possible to generate such a two-dimensional OCT lateral tomographic image that is similar to the IVUS lateral tomographic image illustrated in FIG. 4A. In addition, also for optical line data, the image processing apparatus 3 is able to generate such a two-dimensional OCT longitudinal tomographic image that is similar to the IVUS longitudinal tomographic image illustrated in FIG. 4B, from pieces of optical line data each received at a desired rotation angle and pieces of optical line data each received at a rotation angle acquired by adding 180 degrees to the desired rotation angle.

The imaging catheter 1 has a marker that does not allow X-rays to pass through for use in confirming a positional relationship between an IVUS image that the IVUS sensor 12a acquires and/or an OCT image that the OCT sensor 12b acquires and an angiogram that the angiography apparatus 102 acquires. In the example illustrated in FIG. 2, a marker 14a is provided on the distal end portion of the catheter sheath 11a, that is, for example, is provided on the guide wire insertion portion 14, and a marker 12c is provided on the sensor unit 12 at a position near the shaft 13. When the imaging catheter 1 configured as described above is imaged with X-rays, an angiogram in which the markers 14a and 12c are visualized is acquired. The positions at which the markers 14a and 12c are provided are a mere example, and the marker 12c may be provided on the shaft 13, instead of the sensor unit 12, and the marker 14a may be provided at a location other than the distal end portion of the catheter sheath 11a. In addition, although, in the present embodiment, each of the IVUS sensor 12a and the OCT sensor 12b is configured to acquire 512 pieces of line data, the number of pieces of line data that each of the IVUS sensor 12a and the OCT sensor 12b acquires is not limited to 512.

FIG. 5 is a block diagram illustrating a configuration example of the image processing apparatus 3. The image processing apparatus 3 includes a control unit 31, a main storage unit 32, an input/output unit 33, a communication unit 34, an auxiliary storage unit 35, and a reading unit 36. The control unit 31 includes one or more arithmetic processing units such as a central processing unit (CPU), a micro-processing unit (MPU), a graphics processing unit (GPU), a general-purpose computing on graphics processing unit (GPGPU), and a tensor processing unit (TPU). The control unit 31 is connected to each hardware unit constituting the image processing apparatus 3 via a bus. Note that, when the control unit 31 includes a plurality of arithmetic processing units, the control unit 31 may allow the arithmetic processing units to each separately execute each processing.

The main storage unit 32 serves as a temporary storage unit, is, for example, a static random access memory (SRAM), a dynamic random access memory (DRAM), or a flash memory, and temporarily stores data necessary for the control unit 31 to execute arithmetic processing.

The input/output unit 33 includes an interface circuit to which external apparatuses such as the intravascular inspection apparatus 101, the angiography apparatus 102, the display apparatus 4, and the input apparatus 5 are connected. The control unit 31 acquires reflected wave data of ultrasonic waves and reflected light data of measurement light from the intravascular inspection apparatus 101 via the input/output unit 33, and acquires an angiogram from the angiography apparatus 102. Note that the control unit 31 generates ultrasonic line data from the reflected wave data acquired from the intravascular inspection apparatus 101, and, furthermore, generates an IVUS image. In addition, the control unit 31 generates optical line data from the reflected light data acquired from the intravascular inspection apparatus 101, and, furthermore, generates an OCT image. In addition, the control unit 31 outputs a medical image signal pertaining to an IVUS image, an OCT image, or an angiogram to the display apparatus 4 via the input/output unit 33 to cause the display apparatus 4 to display a medical image. Furthermore, the control unit 31 receives information that has been input to the input apparatus 5 via the input/output unit 33.

The communication unit 34 includes, for example, a communication interface circuit conforming to communication standards such as 4G, 5G, and WiFi. The image processing apparatus 3 communicates with an external server such as a cloud server connected to an external network such as the Internet via the communication unit 34. The control unit 31 may be one that accesses an external server via the communication unit 34 and refers to various types of data stored in a storage in the external server. Furthermore, the control unit 31 may be one that cooperates with the external server to perform, for example, inter-process communications to perform the processing in the present embodiment.

The auxiliary storage unit 35 is a storage device such as a hard disk or a solid state drive (SSD). The auxiliary storage unit 35 stores a program P that the control unit 31 executes and various types of data necessary for allowing the control unit 31 to perform processing. Note that the auxiliary storage unit 35 may be an external storage apparatus connected to the image processing apparatus 3. The program P may be written on the auxiliary storage unit 35 in a manufacturing stage of the image processing apparatus 3, or may be one that a remote server apparatus distributes, that the image processing apparatus 3 acquires through communications, and that the auxiliary storage unit 35 stores. The program P may be recorded in a readable manner on a recording medium 30, such as a magnetic disk, an optical disk, or a semiconductor memory, or may be read by the reading unit 36 from the recording medium 30 and stored in the auxiliary storage unit 35.

The image processing apparatus 3 is not limited to a single computer, but may be a multi-computer including a plurality of computers. In addition, the image processing apparatus 3 may be a server client system, a cloud server, or a virtual machine virtually constructed in a software manner. Hereinafter, description will be given under assumption that the image processing apparatus 3 is a single computer. Although, in the present embodiment, the image processing apparatus 3 is connected to the angiography apparatus 102 that captures two-dimensional angiograms, the present invention is not limited to the angiography apparatus 102, as long as it is an apparatus that images a luminal organ of a patient and the imaging catheter 1 in a plurality of directions from outside a living body.

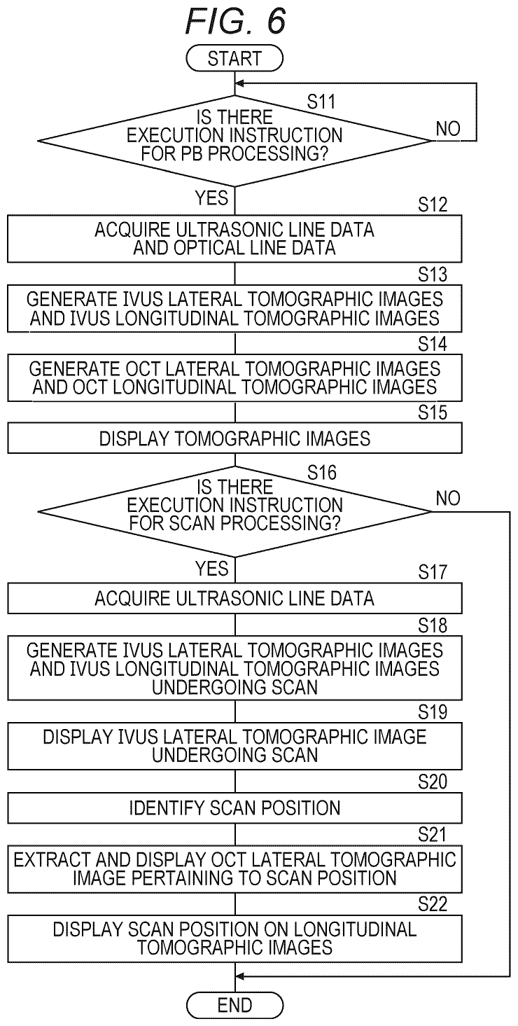

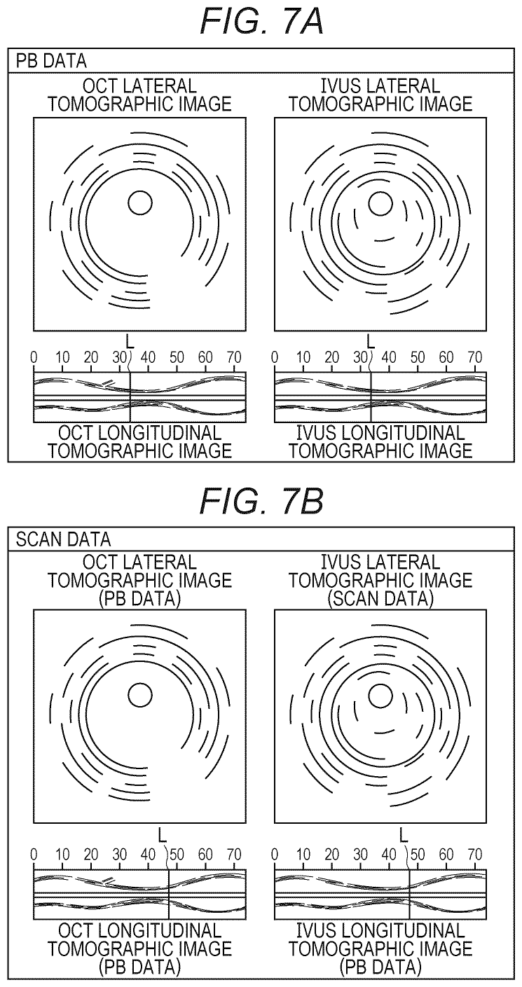

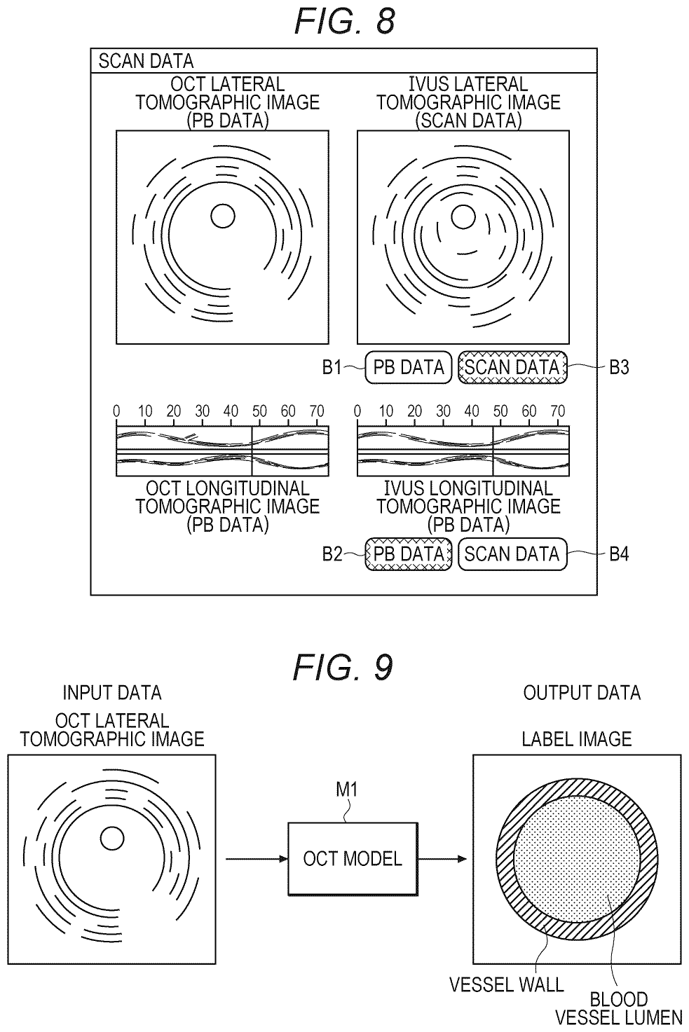

Processing that the image processing apparatus 3 performs will be described herein. FIG. 6 is a flowchart of a display processing procedure for tomographic images, and FIGS. 7A to 8 are diagrams illustrating screen examples. In the image processing apparatus 3 according to the present embodiment, the control unit 31 reads and executes the program P stored in the auxiliary storage unit 35, generates ultrasonic line data from reflected wave data that the IVUS sensor 12a has received, and generates optical line data from reflected light data that the OCT sensor 12b has received. In addition, the control unit 31 performs processing of generating IVUS lateral tomographic images and IVUS longitudinal tomographic images based on the ultrasonic line data, and performs processing of generating OCT lateral tomographic images and OCT longitudinal tomographic images based on the optical line data.

A PCI surgeon performs imaging with the IVUS sensor 12a and the OCT sensor 12b at appropriate timings, such as before expanding a blood vessel with a balloon catheter, after expanding the blood vessel (before placing a stent), after placing the stent, and after press-fitting (performing post-dilating) the placed stent with the balloon catheter, and observes a treatment-target region with the acquired tomographic images. Processing described below may be executed at any of the timings described above. When a treatment-target region is to be observed, such processing is performed that a pull-back operation is used, an imaging core is moved, and both ultrasonic line data and optical line data are acquired. Note that, since, in imaging with the OCT sensor 12b, irregular reflection and attenuation of light may occur due to blood containing a blood cell component such as red blood cells, a flush operation is performed to create a state where there is temporarily no blood (a state where blood is replaced with a flush liquid) by injecting the flush liquid including a contrast agent, low-molecular-weight dextran, or physiological saline, for example, into a blood vessel. Therefore, with the OCT sensor 12b, it is difficult for a surgeon, for example, to manually move an observation position with the OCT sensor 12b and confirm a condition of the blood vessel. On the other hand, since the IVUS sensor 12a does not require such a flush operation, it is possible to allow the surgeon, for example, to manually move the observation position with the IVUS sensor 12a and confirm (scan) the condition of the blood vessel. Therefore, in PCI, in addition to processing of performing a pull-back operation and performing imaging with the IVUS sensor 12a and the OCT sensor 12b (hereinafter referred to as PB processing), processing of performing only imaging with the IVUS sensor 12a (hereinafter referred to as SCAN processing) is performed. For example, after the PB processing is performed to acquire a series of IVUS images and OCT images, the surgeon moves the sensor unit 12 to a desired position while the imaging catheter 1 is not removed (while an insertion position in the blood vessel is not changed), performs the SCAN processing, and observes the treatment target region in detail in the IVUS images. The image processing apparatus 3 follows an input of the surgeon via the input apparatus 5 to control the MDU 2 to switch whether to perform the PB processing or the SCAN processing. Note that the PB processing is not limited to have such a configuration of performing imaging with both the IVUS sensor 12a and the OCT sensor 12b, and may have a configuration of performing only imaging with the OCT sensor 12b.

The control unit 31 receives an operation input from the surgeon via the input apparatus 5, determines whether an execution instruction for the PB processing has been received (S11), and, when it is determined that no such instruction has been received (S11: NO), waits until such an instruction is received. When it is determined that an execution instruction for the PB processing has been received (S11: YES), the control unit 31 starts imaging processing (PB processing) inside the blood vessel with the intravascular inspection apparatus 101, and acquires ultrasonic line data acquired through imaging with the IVUS sensor 12a and optical line data acquired through imaging with the OCT sensor 12b (S12). In here, the intravascular inspection apparatus 101 moves the sensor unit 12 of the imaging catheter 1 from the distal end side to the proximal end side, performs scanning inside the blood vessel, and acquires a series of ultrasonic line data and optical line data. The control unit 31 in the image processing apparatus 3 acquires the series of ultrasonic line data and optical line data that the intravascular inspection apparatus 101 has acquired via the input/output unit 33. Note that the control unit 31 generates, when reflected wave data of ultrasonic waves is acquired from the IVUS sensor 12a via the MDU 2, ultrasonic line data from the acquired reflected wave data of the ultrasonic waves, and generates, when reflected light data is acquired from the OCT sensor 12b via the MDU 2, optical line data from the acquired reflected light data.

The control unit 31 generates IVUS lateral tomographic images and IVUS longitudinal tomographic images based on the ultrasound line data (S13). Specifically, the control unit 31 performs, for 512 pieces of ultrasonic line data acquired while the sensor unit 12 rotates once, interpolation processing on the 512 pieces of ultrasonic line data, interpolates pixels, and constructs a two-dimensional IVUS lateral tomographic image. In addition, the control unit 31 extracts pieces of ultrasonic line data of a desired line number (pieces of ultrasound line data of an identical line number) and pieces of ultrasonic line data of a line number acquired by adding 256 to the desired line number, arranges the extracted pieces of ultrasonic line data in an order of the imaging positions, and constructs a two-dimensional IVUS longitudinal tomographic image. The control unit 31 stores the constructed IVUS lateral tomographic images and the constructed IVUS longitudinal tomographic images in the main storage unit 32 or the auxiliary storage unit 35. Similarly, the control unit 31 generates OCT lateral tomographic images and OCT longitudinal tomographic images based on optical line data (S14), and stores the constructed OCT lateral tomographic images and the constructed OCT longitudinal tomographic images in the main storage unit 32 or the auxiliary storage unit 35.

The control unit 31 causes the display apparatus 4 to display one of the IVUS lateral tomographic images, one of the IVUS longitudinal tomographic images, one of the OCT lateral tomographic images, and one of the OCT longitudinal tomographic images generated and stored in the main storage unit 32 or the auxiliary storage unit 35 (S15). In here, the control unit 31 causes a screen as illustrated in FIG. 7A to be displayed. The screen illustrated in FIG. 7A displays in an arranged manner the OCT lateral tomographic image, the OCT longitudinal tomographic image, the IVUS lateral tomographic image, and the IVUS longitudinal tomographic image (PB data) acquired through the PB processing. Note that the OCT lateral tomographic image and the IVUS lateral tomographic image are lateral tomographic images captured at an identical position in the long-axis directions of the blood vessel, and are images captured at an identical timing (simultaneously) in the PB processing. The imaging position of the lateral tomographic images is indicated by a mark L in each of the OCT longitudinal tomographic image and the IVUS longitudinal tomographic image. In the screen illustrated in FIG. 7A, when the mark L on one of the longitudinal tomographic images is moved leftward or rightward via the input apparatus 5, for example, the control unit 31 moves in a linked manner the mark L on the other one of the longitudinal tomographic images, and switches the lateral tomographic images, which are currently displayed, to other ones of the lateral tomographic images, the imaging position of which corresponds to the positions of the marks L that have been moved. As a result, the surgeon is able to appropriately change an observation position (imaging position) and confirm the tomographic images acquired through the PB processing. Note that imaging directions on an upper end side and a lower end side of each of the longitudinal tomographic images coincide with imaging directions on the upper end side and the lower end side of each of the lateral tomographic images, and, when it is instructed to rotate one of the lateral tomographic images via the input apparatus 5, for example, the control unit 31 further rotates in a linked manner the other one of the lateral tomographic images, and switches the longitudinal tomographic images being displayed to longitudinal tomographic images, the imaging directions of which correspond to the directions on the upper end side and the lower end side of each of the lateral tomographic images that have been rotated. As a result, the surgeon is able to appropriately change an observation direction (imaging angle) and confirm the longitudinal tomographic images acquired through the PB processing.

On the screen illustrated in FIG. 7A, the surgeon observes the condition of the treatment-target region with the OCT images and the IVUS images acquired through the PB processing, and instructs execution of the SCAN processing via the input apparatus 5 when the SCAN processing is desired to be further performed while the imaging catheter 1 is not removed. The control unit 31 determines whether an execution instruction for the SCAN processing has been received (S16), and ends the series of processing when it is determined that no such instruction has been received (S16: NO). Note that, when the position of one of the marks L in the screen has been moved in a state where the screen illustrated in FIG. 7A has been displayed on the display apparatus 4, the control unit 31 continues the processing of moving the marks L on the OCT longitudinal tomographic image and the IVUS longitudinal tomographic image and performing switching of displaying to another one of the OCT lateral tomographic images and another one of the IVUS lateral tomographic images, the imaging positions of which correspond to the positions of the marks L, which have been moved. In addition, when the lateral tomographic images in the screen are rotated, the control unit 31 continues the processing of rotating the lateral tomographic images and performing switching of displaying to longitudinal tomographic images, the imaging directions of which correspond to the directions on the upper end side and the lower end side of each of the lateral tomographic images that have been rotated.

When it is determined that an execution instruction for the SCAN processing has been received (S16: YES), the control unit 31 performs imaging processing (the SCAN processing) inside the blood vessel with the intravascular inspection apparatus 101, and acquires ultrasonic line data acquired through the imaging with the IVUS sensor 12a (S17). In here, the intravascular inspection apparatus 101 performs imaging with the IVUS sensor 12a at a position that the surgeon has designated. In addition, when the surgeon has instructed to move the imaging catheter 1 and perform imaging, the intravascular inspection apparatus 101 moves the sensor unit 12 of the imaging catheter 1 within a range that the surgeon has designated, performs imaging with the IVUS sensor 12a, and acquires a series of pieces of ultrasonic line data. The control unit 31 generates IVUS lateral tomographic images and IVUS longitudinal tomographic images undergoing SCAN based on the acquired ultrasonic line data (S18). The processing in here is identical to S13.

The control unit 31 causes the display apparatus 4 to display one of the IVUS lateral tomographic images undergoing SCAN (S19). In here, the control unit 31 switches the displayed screen from the screen illustrated in FIG. 7A to a screen illustrated in FIG. 7B. The screen illustrated in FIG. 7B displays the OCT lateral tomographic image, the OCT longitudinal tomographic image, and the IVUS longitudinal tomographic image acquired through the PB processing and the IVUS lateral tomographic image acquired through the SCAN processing. Note that information (PB data) indicating that the tomographic images have been acquired through the PB processing is displayed in an associated manner in the OCT lateral tomographic image, the OCT longitudinal tomographic image, and the IVUS longitudinal tomographic image, and information (SCAN data) indicating that the tomographic image has been acquired through the SCAN processing is displayed in an associated manner in the IVUS lateral tomographic image. As a result, the surgeon is able to know whether each of the tomographic images is the PB data or the SCAN data.

The control unit 31 identifies the imaging position (SCAN position) of the IVUS lateral tomographic image undergoing SCAN, which has been displayed at S19 (S20). Since, in the SCAN processing, the insertion position of the imaging catheter 1 in the blood vessel has not been changed from that in the PB processing, the control unit 31 identifies the SCAN position based on, for example, the initial position of the sensor unit 12 in the PB processing (start position of the PB processing) in the long-axis directions of the blood vessel. Specifically, the MDU 2 includes a drive unit (motor) that moves the sensor unit 12 and the shaft 13 in one of the long-axis directions of the probe 11, and the SCAN position in the long-axis directions of the probe 11 is acquired based on a movement distance of the sensor unit 12 by the drive unit. In addition, the MDU 2 may include a long-axis position sensor that measures the position of the sensor unit 12 in the long-axis directions of the probe 11, and the control unit 31 may acquire the SCAN position in the long-axis directions of the probe 11, which the long-axis position sensor measures.

The control unit 31 extracts an OCT lateral tomographic image, the imaging position of which corresponds to the identified SCAN position, from the OCT lateral tomographic images that are the PB data acquired at S14 and allows the extracted image to be displayed (S21). Note that, since the SCAN position is a position based on the start position of the sensor unit 12 in the PB processing, for example, an OCT lateral tomographic image (PB data) that is identical in imaging position to the IVUS lateral tomographic image acquired in the SCAN processing is displayed in here. Specifically, the control unit 31 changes the OCT lateral tomographic image in the screen illustrated in FIG. 7B to the extracted OCT lateral tomographic image. In addition, the control unit 31 moves the marks L on the OCT longitudinal tomographic image and the IVUS longitudinal tomographic image to positions corresponding to the SCAN position to display the SCAN position on the longitudinal tomographic images (S22). As a result, in the SCAN processing, in addition to the IVUS lateral tomographic image undergoing SCAN, the OCT lateral tomographic image that is identical in imaging position to the IVUS lateral tomographic image is displayed. Therefore, the surgeon is able to observe the treatment-target region with the IVUS lateral tomographic image and the OCT lateral tomographic image being displayed. Note that it is assumed that, for the surgeon, in the SCAN processing, there are a case where the sensor unit 12 is moved in the blood vessel and the blood vessel is observed with an IVUS image captured at each imaging position and a case where the blood vessel is observed with the IVUS image captured at the identical position while the sensor unit 12 is not moved. The control unit 31 returns to S17 in the processing after S22 in the processing until it is instructed to end the SCAN processing, and performs S17 to S22 in the processing for the position of the sensor unit 12 at this time point. As a result, when the sensor unit 12 is moved and observation is performed, the control unit 31 is able to cause the screen illustrated in FIG. 7B to sequentially display an IVUS lateral tomographic image captured at the imaging position after movement and an OCT lateral tomographic image that is the PB data, which has been captured at the imaging position identical to that of the IVUS lateral tomographic image. In addition, when observation is performed while the sensor unit 12 is not moved, the control unit 31 sequentially updates only the IVUS lateral tomographic image displayed on the screen illustrated in FIG. 7B with an IVUS lateral tomographic image to be captured at the identical imaging position. As a result, it is possible to update and display the IVUS lateral tomographic image captured at the identical imaging position, and it is possible to allow the OCT lateral tomographic image that is PB data, which has been captured at the imaging position identical to that of the IVUS lateral tomographic image, to be continuously displayed.

Note that the control unit 31 may identify, at S20, an imaging-start direction (SCAN-start direction) in one of the circumferential directions of a blood vessel, in addition to the SCAN position in the long-axis directions of the blood vessel. For example, the control unit 31 identifies an imaging direction of first ultrasonic line data among pieces of ultrasonic line data acquired during one rotation in the circumferential directions of the probe 11 (circumferential directions of the blood vessel). Specifically, the MDU 2 includes the drive unit (motor) that moves the sensor unit 12 and the shaft 13 in one of the circumferential directions of the probe 11, and acquires a SCAN start direction in one of the circumferential directions of the probe 11 based on an amount of rotation of the sensor unit 12 by the drive unit. In addition, when a line number is associated with each line data, an imaging direction of the line data of a line number of 0 may be regarded as the SCAN start direction. In addition, the MDU 2 may include an angle sensor that measures an absolute angle as an imaging direction of the sensor unit 12 in one of the circumferential directions of the probe 11, and the control unit 31 may acquire a SCAN start direction from an angle measured by the angle sensor. Then, when the OCT lateral tomographic image in the screen illustrated in FIG. 7B is to be changed to the OCT lateral tomographic image extracted at S21, the control unit 31 rotates the OCT lateral tomographic image and causes the rotated image to be displayed such that, for example, the SCAN start direction appears on the upper end side. In addition, the control unit 31 moves, at S22, the marks L in the OCT longitudinal tomographic image and the IVUS longitudinal tomographic image to positions corresponding to the SCAN position. At this time, the control unit 31 may generate an OCT longitudinal tomographic image and an IVUS longitudinal tomographic image in which the SCAN start direction appears on the upper end side and cause the images to be displayed, and move the marks L on the OCT longitudinal tomographic image and the IVUS longitudinal tomographic image. As a result, it is possible to cause an OCT lateral tomographic image and an OCT longitudinal tomographic image captured at an imaging position and in an imaging direction identical to those of an IVUS lateral tomographic image undergoing SCAN to be displayed. Note that the IVUS longitudinal tomographic image displayed on the screen illustrated in FIG. 7B may be an IVUS longitudinal tomographic image captured through the SCAN processing, instead of an IVUS longitudinal tomographic image captured through the PB processing. For example, at the start time point of the SCAN processing, an IVUS longitudinal tomographic image that is PB data may be displayed, and, when an IVUS longitudinal tomographic image is generated based on ultrasonic line data acquired through the SCAN processing, the IVUS longitudinal tomographic image at the scan position (observation position) may be updated to the generated IVUS longitudinal tomographic image (IVUS longitudinal tomographic image that is SCAN data). When such a configuration has been applied, it is possible to know, at the start time point of the SCAN processing, the observation position with the IVUS longitudinal tomographic image that is PB data, and it is possible to display, as the SCAN processing proceeds, an IVUS longitudinal tomographic image based on ultrasonic line data acquired at each observation position through the SCAN processing.

In the processing described above, display processing of, after a SCAN position has been identified, an OCT lateral tomographic image, the imaging position of which corresponds to the SCAN position, movement processing of the mark L on an OCT longitudinal tomographic image, and movement processing of the mark L on an IVUS longitudinal tomographic image may be performed in any order. In addition, the control unit 31 may cause, at S21, a screen illustrated in FIG. 8 to be displayed, instead of the screen illustrated in FIG. 7B. The screen illustrated in FIG. 8 accepts an input of switching between PB data acquired through the PB processing and SCAN data acquired through the SCAN processing and displays the switched data, for an IVUS lateral tomographic image and an IVUS longitudinal tomographic image, in addition to a configuration similar to that illustrated in FIG. 7B. Specifically, the screen illustrated in FIG. 8 is provided with PB data buttons B1 and B2 for instructing displaying of an IVUS lateral tomographic image and an IVUS longitudinal tomographic image based on ultrasonic line data acquired through the PB processing and SCAN data buttons B3 and B4 for instructing displaying of an IVUS lateral tomographic image and an IVUS longitudinal tomographic image based on ultrasonic line data acquired through the SCAN processing. When the PB data button B1 is operated on the screen illustrated in FIG. 8, the control unit 31 extracts an IVUS lateral tomographic image captured at an imaging position and an imaging direction identical to those of the OCT lateral tomographic image being displayed from the IVUS lateral tomographic images acquired at S13, and causes the extracted IVUS lateral tomographic image to be displayed. On the other hand, when the SCAN data button B3 is operated, the control unit 31 causes one of the IVUS lateral tomographic images acquired at S18 to be displayed. At this time, the control unit 31 performs S21 to S22 in the processing, and causes an OCT lateral tomographic image that is identical in imaging position to the IVUS lateral tomographic image (SCAN data) being displayed to be displayed. Note that, when there is an image that is identical in imaging position to the OCT lateral tomographic image being displayed in the IVUS lateral tomographic images acquired at S18, the control unit 31 may extract the IVUS lateral tomographic image captured at the imaging position and the imaging direction identical to those of the OCT lateral tomographic image being displayed from the IVUS lateral tomographic images acquired at S18 and may cause the extracted image to be displayed. Similarly, when the PB data button B2 is operated on the screen illustrated in FIG. 8, the control unit 31 generates an IVUS longitudinal tomographic image, the imaging directions of which correspond to the directions on the upper end side and the lower end side of the IVUS lateral tomographic image being displayed, based on the ultrasonic line data acquired at S12 and causes the constructed image to be displayed. On the other hand, when the SCAN data button B4 is operated on the screen illustrated in FIG. 8, the control unit 31 generates an IVUS longitudinal tomographic image, the imaging directions of which correspond to the directions on the upper end side and the lower end side of the IVUS lateral tomographic image being displayed, based on the ultrasonic line data acquired at S17 and causes the constructed image to be displayed.

With the processing described above, in the present embodiment, when the SCAN processing is executed while the imaging catheter 1 is not removed after the PB processing is executed, an IVUS image acquired through the SCAN processing is displayed, and, among OCT images acquired through the PB processing, an OCT image captured at the imaging position identical to that of the IVUS image undergoing SCAN is also displayed in an arranged manner. That is, between an OCT image acquired through the PB processing and an IVUS image acquired through the SCAN processing, it is possible to perform alignment of the imaging positions of an OCT lateral tomographic image and an IVUS lateral tomographic image to be displayed.

### Second Embodiment

An image diagnosis apparatus that corrects a SCAN position based on a merkmal or a landmark such as a position of a side branch of a blood vessel that is an observation target in the PB processing and the SCAN processing and a position where a blood vessel lumen diameter or a blood vessel diameter changes, when the imaging position (SCAN position) of an IVUS lateral tomographic image acquired through the SCAN processing is to be identified will be described. Since it is possible to achieve the image diagnosis apparatus 100 according to the present embodiment with apparatuses similar or identical to the apparatuses in the image diagnosis apparatus 100 according to the first embodiment, description of a similar configuration will be omitted.

In the image diagnosis apparatus 100 according to a second embodiment, a learning model having undergone machine learning for learning training data, for example, is stored in the auxiliary storage unit 35 in the image processing apparatus 3. The learning model is assumed to be utilized as a program module that configures artificial intelligence software. The learning model performs a predetermined arithmetic operation on an input value, and outputs a result of the arithmetic operation, and the auxiliary storage unit 35 stores data such as a coefficient of and a threshold for a mathematical function that defines this arithmetic operation as the learning model. In the present embodiment, the auxiliary storage unit 35 stores, as the learning model, an OCT model M1 that receives an OCT lateral tomographic image as an input and recognizes regions of a blood vessel lumen and a vessel wall in the inputted OCT lateral tomographic image and an IVUS model M2 that receives an IVUS lateral tomographic image acquired through the SCAN processing as an input and recognizes regions of the blood vessel lumen and the vessel wall in the inputted IVUS lateral tomographic image. Note that the auxiliary storage unit 35 may store a model that receives an IVUS lateral tomographic image acquired through the PB processing as an input and recognizes regions of a blood vessel lumen and a vessel wall in the inputted IVUS lateral tomographic image. Since, in the PB processing, an IVUS image and an OCT image are simultaneously captured, a flush operation is performed and blood cells in an imaging region are removed. On the other hand, since, in the SCAN processing, only an IVUS image is captured, no flush operation is performed. Therefore, whether blood cells are present or not differs between an IVUS image acquired through the PB processing and an IVUS image acquired through the SCAN processing. Therefore, for the IVUS model M2, a model that receives an IVUS lateral tomographic image acquired through the SCAN processing as an input and a model that receives an IVUS lateral tomographic image acquired through the PB processing as an input may be separately prepared. In addition, such a configuration may be applied that one IVUS model M2 is caused to undergo learning with training data based on an IVUS lateral tomographic image acquired through the SCAN processing and training data based on an IVUS lateral tomographic image acquired through the PB processing to make it possible to recognize regions of a blood vessel lumen and a vessel wall for both IVUS images with one model. In addition, the OCT model M1 and the IVUS model M2 may be each configured to recognize regions of a guide wire and a catheter, in addition to regions of a blood vessel lumen and a vessel wall from an OCT lateral tomographic image or an IVUS lateral tomographic image.

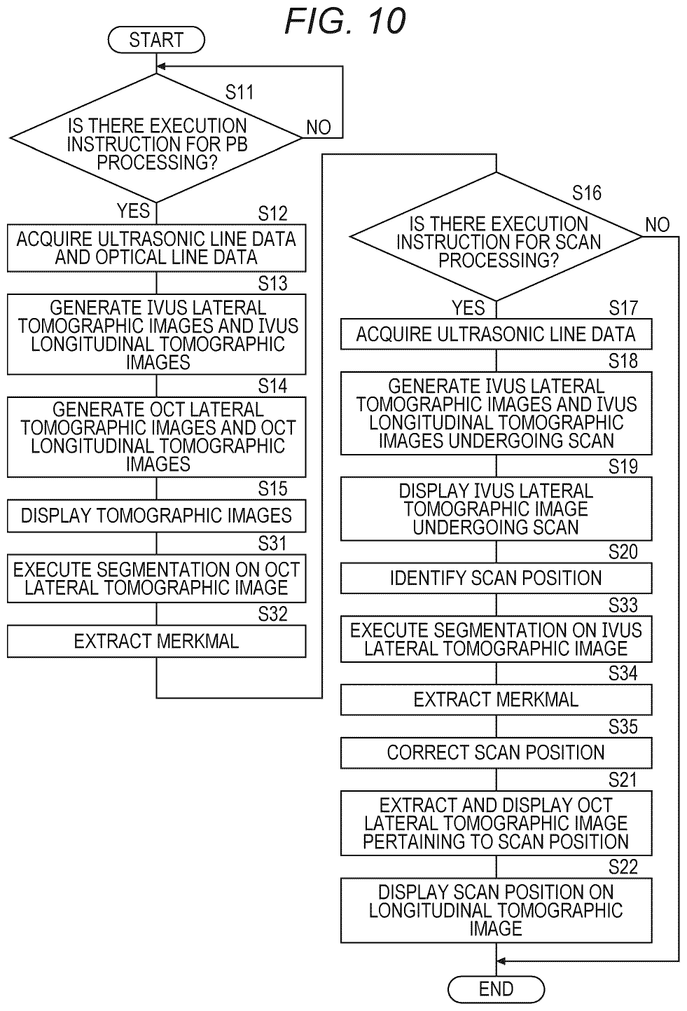

FIG. 9 is a diagram illustrating a configuration example of the OCT model M1. The OCT model M1 is a computer model that recognizes a predetermined object included in an inputted OCT lateral tomographic image, and is able to classify the object in the image in a unit of pixel based on semantic segmentation, for example. For the OCT model M1, it is possible to configure the model using an algorithm for image segmentation such as DeepLab v3+, U-Net, fully convolutional network (FCN), SegNet, or pyramid scene parsing network (PSPNet), and the model may be configured by combining a plurality of algorithms. In addition, the OCT model M1 may be a learning model for object detection based on, for example, you only look once (YOLO), single shot multi-box detector (SSD), or vision transformer (ViT).

The OCT model M1 undergoes learning to receive one OCT lateral tomographic image as an input, perform an arithmetic operation of recognizing a region of a blood vessel lumen and a region of a vessel wall included in the OCT lateral tomographic image based on the inputted OCT lateral tomographic image, and output information indicating a result of the recognition. Specifically, the OCT model M1 classifies pixels in the inputted OCT lateral tomographic image into a region of a blood vessel lumen, a region of a vessel wall, and other regions, and outputs the OCT lateral tomographic image having undergone the classification in which the pixels are associated with labels respectively corresponding to the regions (hereinafter referred to as a label image). In the example illustrated in FIG. 9, the OCT model M1 outputs a label image in which the pixels classified into the region of the blood vessel lumen and the pixels classified into the region of the vessel wall are respectively indicated in a different hatching manner, and the pixels classified into the other regions are colored in white.

It is possible to generate the OCT model M1 by performing machine learning using training data including an OCT lateral tomographic image for use in training and a label image of correct answers labeled with data indicating objects to be determined (in here, the regions of the blood vessel lumen and the vessel wall) for each of the pixels in the OCT lateral tomographic image. Note that, in the label image of correct answers, labels indicating coordinate ranges corresponding to the regions of the objects and types of the objects are applied to the OCT lateral tomographic image for use in training. When an OCT lateral tomographic image included in training data is inputted, the OCT model M1 undergoes learning to output a label image of correct answers included in the training data. Specifically, the OCT model M1 performs an arithmetic operation based on an input OCT lateral tomographic image, and acquires a result of detection in which objects (in here, the regions of the blood vessel lumen and the vessel wall) have been detected in the image. More specifically, the OCT model M1 acquires, as an output, a label image in which values indicating the types of the classified objects are labeled for the pixels in the OCT lateral tomographic image. Then, the OCT model M1 compares the acquired result of the detection (label image) with the ranges and the types of the objects in the label image of the correct answers, and optimizes parameters such as weighting (coupling coefficient) between neurons to approximate each other both the comparison targets. Although there is no limitation in particular in the method of optimizing parameters, it is possible to use a steepest descent method or an error back propagation method, for example. As a result, when an OCT lateral tomographic image is inputted, it is possible to acquire the OCT model M1 that outputs a label image indicating the region of the blood vessel lumen and the region of the vessel wall in the inputted image.

Since the IVUS model M2 has a configuration similar or identical to that of the OCT model M1 illustrated in FIG. 9, detailed description will be omitted. Note that the IVUS model M2 receives an IVUS lateral tomographic image as an input, classifies pixels in the inputted IVUS lateral tomographic image into the region the blood vessel lumen, the region of the vessel wall, and other regions (label image), and outputs the IVUS lateral tomographic image having undergone the classification in which the pixels are associated with labels respectively corresponding to the regions. In addition, it is possible to generate the IVUS model M2 by performing machine learning using training data including an IVUS lateral tomographic image for use in training and a label image of correct answers labeled with data indicating the regions of the blood vessel lumen and the vessel wall for each of the pixels in the IVUS lateral tomographic image.

The image processing apparatus 3 or another learning apparatus may perform learning on the OCT model M1 and the IVUS model M2. The learned models M1 and M2 generated by performing learning with another learning apparatus are downloaded from the learning apparatus to the image processing apparatus 3 via, for example, a network or the recording medium 30, and stored in the auxiliary storage unit 35.

The OCT model M1 and the IVUS model M2 described above are prepared in advance, and the image processing apparatus 3 uses the models for processing of detecting a merkmal in a blood vessel imaged in an acquired OCT lateral tomographic image and an acquired IVUS lateral tomographic image when the PB processing and the SCAN processing are performed. In the present embodiment, as a merkmal, a position of a blood vessel (hereinafter referred to as a side branch) branching and extending from a blood vessel (hereinafter referred to as a main trunk) into which the imaging catheter 1 is inserted, a position of a narrow section at which a lumen diameter of the main trunk or a blood vessel diameter is narrowed, or a position of a distal end of a guiding catheter, for example, is detected. In addition, the image processing apparatus 3 may detect, as a merkmal, an angle at which a side branch extends with respect to a main trunk, a position and an angle of a piece of tissue outside a blood vessel such as a vein or an epicardium, a position and a distribution of a plaque such as a calcified plaque or a lipid plaque, a position and a distribution of a lesion such as dissociation or a hematoma, or a position at which a device such as a stent is placed, for example.

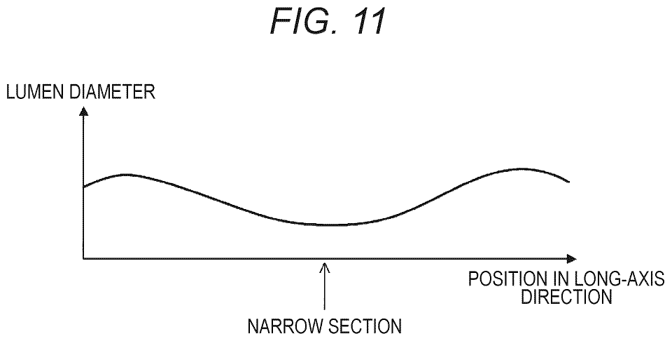

FIG. 10 is a flowchart of a display processing procedure for tomographic images, according to the second embodiment, and FIG. 11 is an explanatory diagram of a merkmal. The processing illustrated in FIG. 10 is one added with S31 and S32 between S15 and S16 and S33 to S35 between S20 and S21, in the processing illustrated in FIG. 6. Description of steps identical to those illustrated in FIG. 6 will be omitted.

In the image diagnosis apparatus 100 according to the present embodiment, the control unit 31 in the image processing apparatus 3 executes S12 to S15 in the processing when an execution instruction for the PB processing is received (S11: YES). After OCT lateral tomographic images are acquired through the PB processing, the control unit 31 executes segmentation on each of a series of the acquired OCT lateral tomographic images (S31). Specifically, the control unit 31 inputs each of the OCT lateral tomographic images to the OCT model M1, and identifies regions of a blood vessel lumen and a vessel wall in the OCT lateral tomographic image based on a label image that is output from the OCT model M1.

The control unit 31 extracts a merkmal in the blood vessel in the OCT lateral tomographic image based on the regions of the blood vessel lumen and the vessel wall in the OCT lateral tomographic image, which have been acquired through the segmentation (S32). For example, the control unit 31 determines whether there is a side branch in the OCT lateral tomographic image, and, when it is determined that there is a side branch, extracts a branch position of the side branch as a merkmal. A side branch in an OCT lateral tomographic image may be detected, for example, through pattern matching using a template image generated from the OCT lateral tomographic image of the blood vessel including the side branch or using a learning model constructed through machine learning.

In a graph illustrated in FIG. 11, a horizontal axis represents a position in the long-axis directions of a blood vessel, and a vertical axis represents a lumen diameter of a main trunk. As illustrated in FIG. 11, for example, the lumen diameter varies depending on the position in the long-axis directions of the blood vessel, and a position at which the lumen diameter is small indicates a narrow section, which is able to be utilized as a merkmal. Note that, in addition to a narrow section, a position at which a lumen diameter or a blood vessel diameter changes, such as a position at which the lumen diameter is larger than that at another position or a position at which a ratio of the lumen diameter with respect to the blood vessel diameter differs from that at another position, may be regarded as a merkmal. Therefore, the control unit 31 calculates a lumen diameter and a blood vessel diameter in the OCT lateral tomographic image, and extracts a position at which the lumen diameter is small (narrow section), a position at which the lumen diameter is large, or a position at which a ratio of the lumen diameter with respect to the blood vessel diameter differs from that at another position as a merkmal. Note that a blood vessel diameter is a diameter of a blood vessel region including a vessel wall and a blood vessel lumen, and a lumen diameter is a diameter of a blood vessel lumen region. The control unit 31 is able to refer to known dimensional information (information of a dimension corresponding to one pixel in terms of millimeter (mm), for example) in the image diagnosis apparatus 100 to calculate actual dimensions of a blood vessel diameter and a lumen diameter. Although, in an output image illustrated in FIG. 9, for simplification of description, a blood vessel region and a blood vessel lumen region are each indicated as a circular region, in an actual lateral tomographic image, these regions are rarely observed as complete circular regions. Therefore, the control unit 31 may perform scanning in one of the circumferential directions with reference to the center (or center of gravity) of each region, and calculate a maximum diameter, a minimum diameter, and an average diameter with respect to each of a blood vessel diameter and a lumen diameter.

In addition, when an execution instruction for the SCAN processing is received (S16: YES), the control unit 31 executes S17 to S20 in the processing. After IVUS lateral tomographic images are acquired through the SCAN processing, the control unit 31 executes segmentation on each of the acquired IVUS lateral tomographic images (S33). Specifically, the control unit 31 inputs each of the IVUS lateral tomographic images to the IVUS model M2, and identifies regions of a blood vessel lumen and a vessel wall in the IVUS lateral tomographic image based on a label image outputted from the IVUS model M2.

The control unit 31 performs processing identical to S32, and extracts a merkmal in the blood vessel in the IVUS lateral tomographic image based on the regions of the blood vessel lumen and the vessel wall in the IVUS lateral tomographic image, which have been acquired through the segmentation (S34). Note that, when a plurality of IVUS lateral tomographic images are acquired through the SCAN processing, the control unit 31 executes segmentation on each of the IVUS lateral tomographic images and extracts a merkmal.

Then, the control unit 31 corrects the SCAN position identified at S20 based on the merkmal extracted from the IVUS lateral tomographic image at S34 and the merkmal extracted from the OCT lateral tomographic image at S32 (S35). For example, the control unit 31 compares the merkmal extracted at S32 from each of the OCT lateral tomographic images each in which a range of a predetermined distance in the long-axis directions from the SCAN position identified at S20 is regarded as the imaging position with the merkmal extracted from the IVUS lateral tomographic image at S34, and identifies one of the OCT lateral tomographic images, in which a most similar merkmal appears. Then, the control unit 31 determines the imaging position of the identified OCT lateral tomographic image as the SCAN position, and corrects the SCAN position identified at S20 to the SCAN position determined in here. Note that the surgeon may manually select an OCT lateral tomographic image captured at the imaging position identical to that of each of IVUS lateral tomographic images acquired through the SCAN processing. In this case, the control unit 31 follows an operation input received from the surgeon via the input apparatus 5 and performs switching of an OCT lateral tomographic image to be displayed, making it possible to display an IVUS lateral tomographic image and an OCT lateral tomographic image that are identical to each other in imaging position.

In addition, the control unit 31 may correct an imaging-start direction (SCAN-start direction) in one of the circumferential directions of a blood vessel, in addition to the SCAN position in the long-axis directions of the blood vessel described above. Also in here, the control unit 31 rotates, based on the merkmal extracted from the OCT lateral tomographic image at S32 and the merkmal extracted from the IVUS lateral tomographic image at S34, one or both of the lateral tomographic images to match or approximate the merkmals in position in the two lateral tomographic images. Note that the surgeon may compare, via a screen displaying an OCT lateral tomographic image and an IVUS lateral tomographic image captured at an identical position in the long-axis directions, the two lateral tomographic images and manually perform alignment in the circumferential directions. In this case, the control unit 31 follows an operation input received from the surgeon via the input apparatus 5, and rotates one of the lateral tomographic images, for which an instruction for rotation has been given to further rotate another one of the lateral tomographic images in a linked manner. Furthermore, the control unit 31 switches the longitudinal tomographic images being displayed on the screen to longitudinal tomographic images, the imaging directions of which correspond to the directions on the upper end side and the lower end side of each of the lateral tomographic images that have been rotated. As a result, it is possible to cause an OCT lateral tomographic image and an OCT longitudinal tomographic image captured at an imaging position and in an imaging direction identical to those of an IVUS lateral tomographic image undergoing SCAN to be displayed. Note that the control unit 31 executes S21 and S22 in the processing based on the corrected SCAN position.

Through the processing described above, even in the present embodiment, between an OCT image acquired through the PB processing and an IVUS image acquired through the SCAN processing, it is possible to perform alignment of the imaging positions of an OCT lateral tomographic image and an IVUS lateral tomographic image to be displayed. Note that, in the present embodiment, correcting (adjusting) the SCAN position identified based on a movement distance of the sensor unit 12 by the MDU 2 or a position measured by a long-axis position sensor included in the MDU 2 based on a merkmal of a blood vessel imaged in an OCT image and an IVUS image makes it possible to perform more accurate alignment. Since the shaft 13 has elasticity and may be bent in one of the long-axis directions, it is impossible to accurately identify the position in the long-axis directions, when bending occurs. Therefore, correcting the imaging position using a merkmal captured in an image as a mark, as described in the present embodiment, makes it possible to more accurately align the imaging positions of an OCT lateral tomographic image and an IVUS lateral tomographic image to be displayed. In addition, in the processing described above, instead of or in addition to the processing of extracting a merkmal from an OCT image (for example, an OCT lateral tomographic image) acquired through the PB processing, processing of extracting a merkmal from an IVUS image (for example, an IVUS lateral tomographic image) acquired through the PB processing may be performed. Since it is possible to associate with each other the imaging positions between an OCT lateral tomographic image and an IVUS lateral tomographic image acquired through the PB processing, it is possible to align the imaging positions between the OCT lateral tomographic image acquired through the PB processing and an IVUS lateral tomographic image acquired through the SCAN processing based on the position of the merkmal extracted from the IVUS lateral tomographic image.

Although, in the present embodiment, there is the configuration where the image processing apparatus 3 locally performs the processing of executing segmentation on an OCT lateral tomographic image using the OCT model M1 to extract a merkmal in the image and the processing of executing segmentation on an IVUS lateral tomographic image using the IVUS model M2 to extract a merkmal in the image, the present invention is not limited to this configuration. For example, a server may be provided for performing processing of extracting a merkmal in an image using the OCT model M1. In this case, the image processing apparatus 3 is configured to transmit an OCT lateral tomographic image acquired through the PB processing to the server, and acquire information indicating the position of a merkmal extracted from the OCT lateral tomographic image in the server. In addition, a server may be provided for performing processing of extracting a merkmal in an image using the IVUS model M2. In this case, the image processing apparatus 3 is configured to transmit an IVUS lateral tomographic image acquired through the SCAN processing to the server, and acquire information indicating the position of a merkmal extracted from the IVUS lateral tomographic image in the server. Even when such a configuration has been applied, it is possible to perform processing similar to that of the present embodiment, and acquire a similar effect. Note that, even in the present embodiment, it is possible to apply the modified examples described as appropriate in the first embodiment described above.

### Third Embodiment

In the image diagnosis apparatus 100 according to the first or second embodiment, it is possible to display in an arranged manner an OCT lateral tomographic image and an IVUS lateral tomographic image captured at the identical imaging position among OCT images acquired through the PB processing and IVUS images acquired through the SCAN processing. Images to be displayed in an arranged manner are not limited to an OCT lateral tomographic image and an OCT longitudinal tomographic image generated from optical line data and an IVUS lateral tomographic image and an IVUS longitudinal tomographic image constructed from ultrasonic line data as illustrated in FIGS. 7A to 8. In a third embodiment, there will be described an image diagnosis apparatus that estimates a blood vessel lumen diameter and a blood vessel diameter (inner diameter of a luminal organ) that are targets of imaging based on OCT lateral tomographic images and/or IVUS lateral tomographic images, creates an estimation image of a longitudinal tomographic image of the blood vessel based on the estimated blood vessel lumen diameter and the estimated blood vessel diameter, and causes the estimation blood vessel image that has been created to be displayed. Since it is possible to achieve the image diagnosis apparatus 100 according to the present embodiment with apparatuses similar or identical to the apparatuses in the image diagnosis apparatus 100 according to the first embodiment, description of a similar configuration will be omitted.

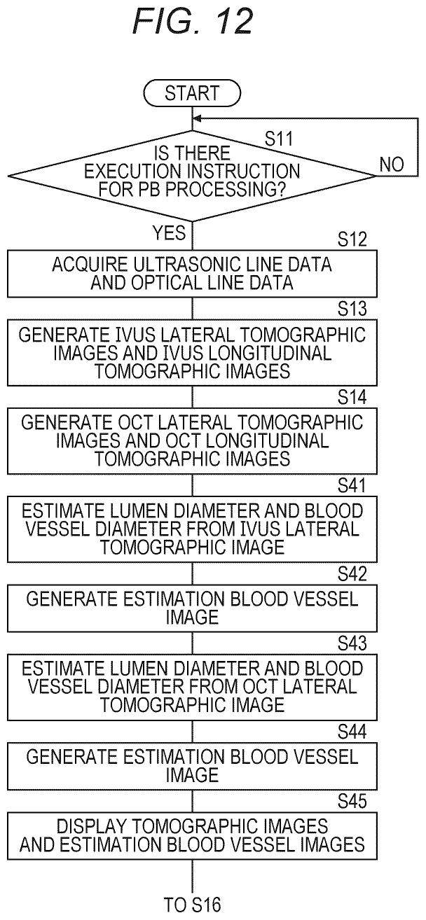

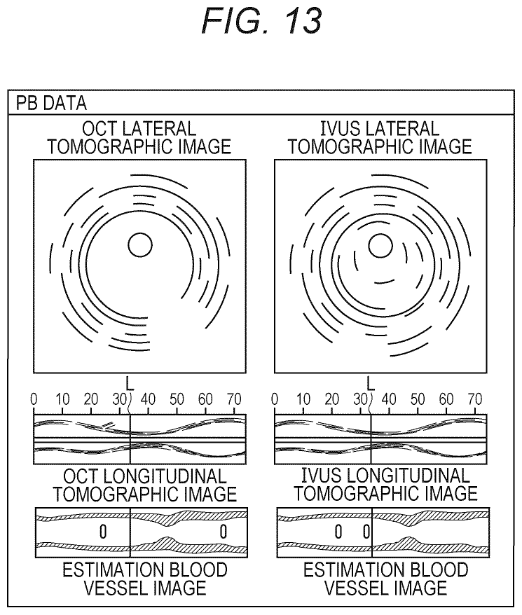

FIG. 12 is a flowchart of a display processing procedure for tomographic images, according to the third embodiment, and FIG. 13 is a diagram illustrating a screen example. The processing illustrated in FIG. 12 is one added with S41 to S45, instead of S15, in the processing illustrated in FIG. 6. Description of steps identical to those illustrated in FIG. 6 will be omitted. In FIG. 12, illustration of S16 to S22 illustrated in FIG. 6 is omitted.

In the image diagnosis apparatus 100 according to the present embodiment, the control unit 31 in the image processing apparatus 3 executes S12 to S14 in the processing when an execution instruction for the PB processing is received (S11: YES). After IVUS lateral tomographic images have been acquired through the PB processing, the control unit 31 estimates a blood vessel lumen diameter and a blood vessel diameter at the imaging position (imaging location) of each of the IVUS lateral tomographic images based on the acquired IVUS lateral tomographic images (S41). For example, the control unit 31 inputs each of the IVUS lateral tomographic images to the IVUS model M2 described in the second embodiment, and identifies regions of a blood vessel lumen and a vessel wall in the IVUS lateral tomographic image based on a label image outputted from the IVUS model M2. Then, the control unit 31 calculates an average value of the blood vessel lumen diameter and an average value of the blood vessel diameter. The control unit 31 calculates an average value of the blood vessel lumen diameter and an average value of the blood vessel diameter for each of the IVUS lateral tomographic images acquired through the PB processing, and generates an estimation image (estimation blood vessel image) of a longitudinal tomogram of the blood vessel based on the average value of the blood vessel lumen diameter and the average value of the blood vessel diameter at each imaging position (S42). Note that the control unit 31 may calculate cross-sectional areas of a blood vessel lumen and the blood vessel, instead of average values of a blood vessel lumen diameter and a blood vessel diameter, and generate an estimation blood vessel image representing the blood vessel lumen and the blood vessel in a form of circles having the calculated cross-sectional areas of the blood vessel lumen and the blood vessel.

Similarly, after OCT lateral tomographic images have been acquired through the PB processing, the control unit 31 estimates a blood vessel lumen diameter and a blood vessel diameter at the imaging position (imaging location) of each of the OCT lateral tomographic images based on the acquired OCT lateral tomographic images (S43). The control unit 31 calculates an average value of the blood vessel lumen diameter and an average value of the blood vessel diameter for each of the OCT lateral tomographic images acquired through the PB processing, and generates an estimation image (estimation blood vessel image) of a longitudinal tomogram of the blood vessel based on the average value of the blood vessel lumen diameter and the average value of the blood vessel diameter at each imaging position (S44). Also in here, the control unit 31 may calculate cross-sectional areas of a blood vessel lumen and the blood vessel, instead of average values of the blood vessel lumen and the blood vessel diameter, and generate an estimation blood vessel image representing the blood vessel lumen and the blood vessel in a form of circles having the calculated cross-sectional areas of the blood vessel lumen and the blood vessel. Then, as illustrated in FIG. 13, the control unit 31 causes the display apparatus 4 to display the IVUS lateral tomographic image and the IVUS longitudinal tomographic image generated at S13, the OCT lateral tomographic image and the OCT longitudinal tomographic image constructed at S14, the estimation blood vessel image generated from the IVUS lateral tomographic images at S42, and the estimation blood vessel image generated from the OCT lateral tomographic images at S44 (S45). After that, the control unit 31 performs S16 and subsequent steps in the processing.

The screen illustrated in FIG. 13 displays the estimation blood vessel image generated from the IVUS lateral tomographic images and the estimation blood vessel image generated from the OCT lateral tomographic images, in addition to the configuration of the screen illustrated in FIG. 7A. Note that the control unit 31 may cause the screen illustrated in FIG. 7B or 8 to display a screen added with the estimation blood vessel image generated from the IVUS lateral tomographic images and the estimation blood vessel image generated from the OCT lateral tomographic images. As a result, it is possible to display, as longitudinal tomographic images, the estimation blood vessel images based on the blood vessel lumen diameter and the blood vessel diameter, which have been estimated from the OCT lateral tomographic images and the IVUS lateral tomographic images, in addition to the OCT longitudinal tomographic image and the IVUS longitudinal tomographic image acquired through the PB processing. Note that an estimation blood vessel image to be generated from IVUS lateral tomographic images may be an estimation blood vessel image to be generated from IVUS lateral tomographic images sequentially acquired through the SCAN processing, in addition to an estimation blood vessel image to be generated from IVUS lateral tomographic images acquired through the PB processing. In this case, for a region observed through the SCAN processing, an estimation blood vessel image (estimation image of a longitudinal tomogram of a blood vessel) based on IVUS lateral tomographic images acquired through the SCAN processing is generated and displayed.

The configuration of the present embodiment is applicable to the image diagnosis apparatus 100 according to the first or second embodiment described above, and, even when the configuration has been applied to the image diagnosis apparatus 100 according to the first or second embodiment, processing similar to that according to the first and second embodiments is possible except for processing of generating and displaying an estimation blood vessel image, making it possible to acquire a similar effect. In addition, even in the present embodiment, it is possible to apply the modified examples described as appropriate in the first and second embodiments described above.

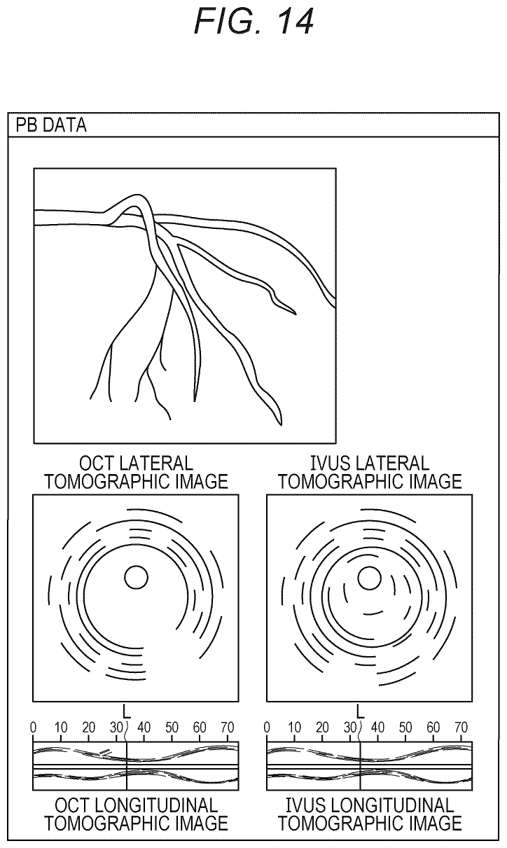

FIG. 14 is a diagram illustrating another example of a screen. As illustrated in FIG. 14, in addition to the IVUS lateral tomographic image and the IVUS longitudinal tomographic image constructed at S13 and the OCT lateral tomographic image and the OCT longitudinal tomographic image constructed at S14, the control unit 31 in the image processing apparatus 3 may cause an angiogram of the blood vessel that is a target to be treated, which has been captured by the angiography apparatus 102, to be displayed. Although the screen illustrated in FIG. 14 displays an angiogram, in addition to the configuration of the screen illustrated in FIG. 7A, the control unit 31 may cause a screen added with an angiogram to be displayed in the screen illustrated in FIG. 7B or 8. In addition, the control unit 31 in the image processing apparatus 3 may combine the screen illustrated in FIG. 13 and the screen illustrated in FIG. 14 to further display, in addition to an OCT lateral tomographic image, an OCT longitudinal tomographic image, an IVUS lateral tomographic image, and an IVUS longitudinal tomographic image, estimation blood vessel images estimated from the OCT lateral tomographic images and the IVUS lateral tomographic images and an angiogram. As described above, displaying in an arranged manner various types of images in which the blood vessel that is a target to be treated is imaged and various types of images generated from the captured images makes it possible to make a confirmation of a treatment-target region from the various types of images during treatment inside the blood vessel.

In addition, information such as a blood vessel lumen diameter and a blood vessel diameter, which are estimated from a captured image may be displayed, in addition to the captured image of the target to be treated and an image generated from the captured image. For example, when there has been a configuration for estimating a blood vessel lumen diameter, a blood vessel diameter, and a plaque region, for example, at a SCAN location, the control unit 31 may cause the screens illustrated in FIGS. 13 and 14 to display how the blood vessel lumen diameter, the blood vessel diameter, and the plaque region spread (for example, spread in the circumferential directions of the blood vessel), for example, at the SCAN location. In this case, the surgeon is able to confirm a state of the target to be treated from the images being displayed, and to more accurately know the state of the target to be treated from the blood vessel lumen diameter, the blood vessel diameter, and the plaque region that have been estimated.

Although, in each of the embodiments described above, there has been the configuration in which the IVUS sensor 12a that captures a tomographic image inside a blood vessel using ultrasonic waves and the OCT sensor 12b that captures a tomographic image inside the blood vessel using near-infrared light are used, the present invention is not limited to such a configuration. For example, instead of the IVUS sensor 12a or the OCT sensor 12b, it is possible to apply such a configuration in which various types of sensors that make it possible to observe a state of a blood vessel, such as a sensor that receives Raman scattered light from the inside of the blood vessel and captures a tomographic image of the inside of the blood vessel and a sensor that receives excitation light from the inside of the blood vessel and captures a tomographic image of the inside of the blood vessel are used.

It should be construed that the embodiments disclosed herein are illustrative in all respects rather than restrictive. The scope of the present invention is indicated not by the above meaning but by the claims and is intended to include all changes within the meaning and scope equivalent to the claims.

What is claimed is:

1. An imaging system for generating tomographic images of a luminal organ, comprising:
a catheter that includes:
an ultrasound sensor configured to transmit ultrasound waves and receive the waves reflected by the luminal organ in a radial direction of the catheter when the catheter is inserted in the luminal organ, and
an optical sensor configured to emit near infrared light and receive the light reflected by the luminal organ in the radial direction when the catheter is inserted in the luminal organ;
a motor drive unit connectable to the catheter and configured to move the ultrasound sensor and the optical sensor in a longitudinal direction of the catheter;
a display;
a memory that stores a program; and
a processor configured to execute the program to perform the steps of:
controlling the motor drive unit to move the optical sensor in a first time period and generating a plurality of optical coherence tomographic images based on light received by the optical sensor in the first time period, each of the optical coherence tomographic images being associated with a location of the optical sensor;
controlling the motor drive unit to move the ultrasound sensor in a second time period that is subsequent to the first time period and generating a plurality of ultrasound tomographic images based on waves received by the ultrasound sensor in the second time period, each of the ultrasound tomographic images being associated with a location of the ultrasound sensor;
generating a first screen that shows one of the optical coherence tomographic images and one of the ultrasound tomographic images that are associated with a same location; and
control the display to display the first screen.

2. The imaging system according to claim 1, wherein
the location of each of the optical sensor and the ultrasound sensor is determined based on a distance of movement of said each of the optical sensor and the ultrasound sensor.

3. The imaging system according to claim 1, wherein
the steps further include associating the optical coherence tomographic images with the ultrasound tomographic images using the locations of the optical sensor and the ultrasound sensor.

4. The imaging system according to claim 3, wherein
the steps further include:
detecting an object of the luminal organ in the optical coherence tomographic images and the ultrasound tomographic images, and
correcting the association of the optical coherence tomographic images with the ultrasound tomographic images based on the detected object.

5. The imaging system according to claim 1, wherein
the motor drive unit is further configured to rotate the optical sensor and the ultrasound sensor,
the steps further include:
determining an orientation of said one of the optical coherence tomographic images based on an amount of rotation of the optical sensor, and
determining an orientation of said one of the ultrasound tomographic images based on an amount of rotation of the ultrasound sensor, and
said one of the optical coherence tomographic images and said one of the ultrasound tomographic images are displayed at the respective determined orientations.

6. The imaging system according to claim 5, wherein
the steps further include:
detecting an object of the luminal organ in the optical coherence tomographic images and the ultrasound tomographic images, and
correcting the orientation of said one of the optical coherence tomographic images and the orientation of said one of the ultrasound tomographic images based on the detected object.

7. The imaging system according to claim 1, wherein
controlling the motor drive unit to move the optical sensor includes moving the ultrasound sensor together with the optical sensor in the first time period and generating a plurality of ultrasound tomographic images based on waves received by the ultrasound sensor in the first time period, each of the ultrasound tomographic images being associated with a location of the ultrasound sensor, and
the steps further include:
generating a second screen that shows one of the optical coherence tomographic images and one of the ultrasound tomographic images that correspond to the first time period and are associated with a same location, and
after the ultrasound tomographic images corresponding to the second time period are generated, switching the second screen to the first screen.

8. The imaging system according to claim 1, wherein
controlling the motor drive unit to move the optical sensor includes generating an optical coherence longitudinal tomographic image showing a longitudinal cross section of the luminal organ based on the light received by the optical sensor in the first time period,
controlling the motor drive unit to move the ultrasound sensor includes generating an ultrasound longitudinal tomographic image showing the longitudinal cross section of the luminal organ based on the waves received by the ultrasound sensor in the second time period, and
the first screen further shows:
the optical coherence longitudinal tomographic image,
a first marker on the optical coherence longitudinal tomographic image, the first marker indicating a location of the luminal organ corresponding to said one of the optical coherence tomographic image,
the ultrasound longitudinal tomographic image, and
a second marker on the ultrasound longitudinal tomographic image, the second marker indicating a location of the luminal organ corresponding to said one of the ultrasound tomographic image.

9. The imaging system according to claim 1, wherein
controlling the motor drive unit to move the optical sensor includes:
moving the ultrasound sensor together with the optical sensor in the first time period and generating a plurality of ultrasound tomographic images based on waves received by the ultrasound sensor in the first time period, each of the ultrasound tomographic images being associated with a location of the ultrasound sensor,
generating an optical coherence longitudinal tomographic image showing a longitudinal cross section of the luminal organ based on the light received by the optical sensor in the first time period,
generating an ultrasound longitudinal tomographic image showing the longitudinal cross section of the luminal organ based on the waves received by the ultrasound sensor in the first time period, and
the steps further include:
generating a second screen that shows:
one of the optical coherence tomographic images and one of the ultrasound tomographic images that correspond to the first time period and are associated with a same location,
the optical coherence longitudinal tomographic image,
a first marker on the optical coherence longitudinal tomographic image, the first marker indicating a location of the luminal organ corresponding to said one of the optical coherence tomographic image,
the ultrasound longitudinal tomographic image, and
a second marker on the ultrasound longitudinal tomographic image, the second marker indicating a location of the luminal organ corresponding to said one of the ultrasound tomographic image.

10. The imaging system according to claim 1, wherein
the steps further include:
determining an inner diameter of the luminal organ at each of different locations based on the optical coherence tomographic images,
generating a longitudinal tomographic image of the luminal organ based on the determined inner diameter, and
displaying the generated longitudinal tomographic image of the luminal organ.

11. A method for generating tomographic images of a luminal organ using an imaging system that includes:
a catheter that includes:
an ultrasound sensor configured to transmit ultrasound waves and receive the waves reflected by the luminal organ in a radial direction of the catheter when the catheter is inserted in the luminal organ, and
an optical sensor configured to emit near infrared light and receive the light reflected by the luminal organ in the radial direction when the catheter is inserted in the luminal organ, and
a motor drive unit connectable to the catheter and configured to move the ultrasound sensor and the optical sensor in a longitudinal direction of the catheter, the method comprising:
controlling the motor drive unit to move the optical sensor in a first time period and generating a plurality of optical coherence tomographic images based on light received by the optical sensor in the first time period, each of the optical coherence tomographic images being associated with a location of the optical sensor;
controlling the motor drive unit to move the ultrasound sensor in a second time period that is subsequent to the first time period and generating a plurality of ultrasound tomographic images based on waves received by the ultrasound sensor in the second time period, each of the ultrasound tomographic images being associated with a location of the ultrasound sensor;
generating a first screen that shows one of the optical coherence tomographic images and one of the ultrasound tomographic images that are associated with a same location; and
displaying the first screen.

12. The method according to claim 11, wherein
the location of each of the optical sensor and the ultrasound sensor is determined based on a distance of movement of said each of the optical sensor and the ultrasound sensor.

13. The method according to claim 11, further comprising:
associating the optical coherence tomographic images with the ultrasound tomographic images using the locations of the optical sensor and the ultrasound sensor.

14. The method according to claim 13, further comprising:
detecting an object of the luminal organ in the optical coherence tomographic images and the ultrasound tomographic images; and
correcting the association of the optical coherence tomographic images with the ultrasound tomographic images based on the detected object.

15. The method according to claim 11, wherein
the motor drive unit is further configured to rotate the optical sensor and the ultrasound sensor,
the method further comprises:
determining an orientation of said one of the optical coherence tomographic images based on an amount of rotation of the optical sensor; and
determining an orientation of said one of the ultrasound tomographic images based on an amount of rotation of the ultrasound sensor, and
said one of the optical coherence tomographic images and said one of the ultrasound tomographic images are displayed at the respective determined orientations.

16. The method according to claim 15, further comprising:
detecting an object of the luminal organ in the optical coherence tomographic images and the ultrasound tomographic images; and
correcting the orientation of said one of the optical coherence tomographic images and the orientation of said one of the ultrasound tomographic images based on the detected object.

17. The method according to claim 11, wherein
controlling the motor drive unit to move the optical sensor includes moving the ultrasound sensor together with the optical sensor in the first time period and generating a plurality of ultrasound tomographic images based on waves received by the ultrasound sensor in the first time period, each of the ultrasound tomographic images being associated with a location of the ultrasound sensor, and
the method further comprises:
generating a second screen that shows one of the optical coherence tomographic images and one of the ultrasound tomographic images that correspond to the first time period and are associated with a same location, and
after the ultrasound tomographic images corresponding to the second time period are generated, switching the second screen to the first screen.

18. The method according to claim 11, wherein
controlling the motor drive unit to move the optical sensor includes generating an optical coherence longitudinal tomographic image showing a longitudinal cross section of the luminal organ based on the light received by the optical sensor in the first time period,
controlling the motor drive unit to move the ultrasound sensor includes generating an ultrasound longitudinal tomographic image showing the longitudinal cross section of the luminal organ based on the waves received by the ultrasound sensor in the second time period, and
the first screen further shows:
the optical coherence longitudinal tomographic image,
a first marker on the optical coherence longitudinal tomographic image, the first marker indicating a location of the luminal organ corresponding to said one of the optical coherence tomographic image,
the ultrasound longitudinal tomographic image, and
a second marker on the ultrasound longitudinal tomographic image, the second marker indicating a location of the luminal organ corresponding to said one of the ultrasound tomographic image.

19. The method according to claim 11, wherein
controlling the motor drive unit to move the optical sensor includes:
moving the ultrasound sensor together with the optical sensor in the first time period and generating a plurality of ultrasound tomographic images based on waves received by the ultrasound sensor in the first time period, each of the ultrasound tomographic images being associated with a location of the ultrasound sensor,
generating an optical coherence longitudinal tomographic image showing a longitudinal cross section of the luminal organ based on the light received by the optical sensor in the first time period,
generating an ultrasound longitudinal tomographic image showing the longitudinal cross section of the luminal organ based on the waves received by the ultrasound sensor in the first time period, and
the method further comprises:
generating a second screen that shows:
one of the optical coherence tomographic images and one of the ultrasound tomographic images that correspond to the first time period and are associated with a same location,
the optical coherence longitudinal tomographic image,
a first marker on the optical coherence longitudinal tomographic image, the first marker indicating a location of the luminal organ corresponding to said one of the optical coherence tomographic image,
the ultrasound longitudinal tomographic image, and
a second marker on the ultrasound longitudinal tomographic image, the second marker indicating a location of the luminal organ corresponding to said one of the ultrasound tomographic image.

20. An image processing apparatus for generating tomographic images of a luminal organ, comprising:
an interface connectable to a motor drive unit that is connectable to a catheter and configured to move an ultrasound sensor and an optical sensor of the catheter in a longitudinal direction of the catheter, wherein
the ultrasound sensor is configured to transmit ultrasound waves and receive the waves reflected by the luminal organ in a radial direction of the catheter when the catheter is inserted in the luminal organ, and
the optical sensor is configured to emit near infrared light and receive the light reflected by the luminal organ in the radial direction when the catheter is inserted in the luminal organ;
a memory that stores a program; and
a processor configured to execute the program to perform the steps of:
controlling the motor drive unit to move the optical sensor in a first time period and generating a plurality of optical coherence tomographic images based on light received by the optical sensor in the first time period, each of the optical coherence tomographic images being associated with a location of the optical sensor,
controlling the motor drive unit to move the ultrasound sensor in a second time period that is subsequent to the first time period and generating a plurality of ultrasound tomographic images based on waves received by the ultrasound sensor in the second time period, each of the ultrasound tomographic images being associated with a location of the ultrasound sensor,
generating a first screen that shows one of the optical coherence tomographic images and one of the ultrasound tomographic images that are associated with a same location, and
outputting the first screen.
